(19) United States
(12) Patent Application Publication
(10) Pub. No.: US 2012/0002046 A1
(43) Pub. Date: Jan. 5, 2012

(54) Flip-Up Hands-Free Display Mount

(75) Inventors: Loren W. Rapoport, Richardson, TX (US); Robert C. Schwalm, Plano, TX (US); Christopher M. Stalzer, Scottsdale, AZ (US)

(73) Assignee: Raytheon Company, Waltham, MA (US)

(21) Appl. No.: 12/904,708

(22) Filed: Oct. 14, 2010

Related U.S. Application Data
(60) Provisional application No. 61/360,242, filed on Jun. 30, 2010.

(51) Int. Cl. H04N 7/18

(52) U.S. Cl. 348/143; 348/E07.091

(57) ABSTRACT

According to one embodiment, a display mount includes a helmet-mountable interface, a display interface, a cam arm, and an adjustment mechanism. The helmet-mountable interface is configured to removably couple the display mount to a helmet. The display interface is configured to couple the display mount to a display. The cam arm is configured to position the display interface in a plurality of positions comprising a storage position and a display position. The adjustment mechanism is configured to adjust, independent of the cam arm, a position of the display interface along an X-axis, a Y-axis and a Z-axis. The X-axis, Y-axis, and Z-axis are each orthogonal to each other. The adjustment mechanism includes a locking mechanism configured to lock an adjusted position of the display interface, such that the display interface mechanically returns to the locked adjusted position when the display interface transitions from the storage position to the display position.

### RELATED APPLICATIONS

This application claims priority to U.S. Provisional Application 61/360,242 filed Jun. 30, 2010, the contents of which are hereby incorporated by reference.

### TECHNICAL FIELD

This disclosure relates in general to display mounts, and more particularly to a flip-up, hands-free display mount.

### BACKGROUND

Various helmet-mounted displays include a display optic fixed in front of one or both eyes of a user. Some helmet-mounted displays can display an entirely computer-generated image. Other helmet-mounted displays can superimpose a computer-generated-image (“CGI”) upon a real-world view, which is sometimes referred to as augmented reality or mixed reality. Particular helmet-mounted displays may be used to provide visual information to a user in a variety of applications including military, governmental (e.g., fire, police, etc.) and civilian/commercial (e.g., medicine, video gaming, sports, etc.).

### SUMMARY OF THE INVENTION

According to one embodiment, a display mount includes a helmet-mountable interface, a display interface, a cam arm, and an adjustment mechanism. The helmet-mountable interface is configured to removably couple the display mount to a helmet. The display interface is configured to couple the display mount to a display. The cam arm is configured to position the display interface in a plurality of positions comprising a storage position and a display position. The adjustment mechanism is configured to adjust, independent of the cam arm, a position of the display interface along an X-axis, a Y-axis and a Z-axis. The X-axis, Y-axis, and Z-axis are each orthogonal to each other. The adjustment mechanism includes a locking mechanism configured to lock an adjusted position of the display interface, such that the display interface mechanically returns to the locked adjusted position when the display interface transitions from the storage position to the display position.

Particular embodiments may provide one or more technical advantages. In certain embodiments, a rugged, hands-free display mount may couple a monocular or binocular display unit to a helmet. The display mount may enable rapid transitioning of the display unit between a viewing position within the field of view of a user and a storage position substantially or completely outside the field of view of the user. In certain embodiments, the display mount may be used to adjust the viewing position of the display unit along at multiple axis. Certain display mounts may mechanically retain a desired viewing position of the display unit, such that the display unit consistently returns to the retained viewing position after repeated transitions between viewing and storage positions. Certain embodiments may provide all, some, or none of these advantages. Certain embodiments may provide one or more other advantages, one or more of which may be apparent to those skilled in the art from the figures, descriptions, and claims included herein.

### BRIEF DESCRIPTION OF THE DRAWINGS

For a more complete understanding of the present invention and advantages thereof, reference is now made to the following description taken in conjunction with the accompanying drawings, in which:

FIGS. 1A through 1H illustrate various views and positions of a display mount configured to removably couple a display unit to a helmet and to adjustably position the display unit within the field of view of a user;

FIG. 2A illustrates internal features of a portion of the display mount of FIG. 1A;

FIG. 2B through 2D illustrate cross-sectional views of portions of the display mount of FIG. 1A; and

FIG. 3 shows the display mount of FIGS. 1A through 1H decoupled from the helmet; and

FIGS. 4A and 4B show a display mount according to an alternative embodiment.

### DETAILED DESCRIPTION

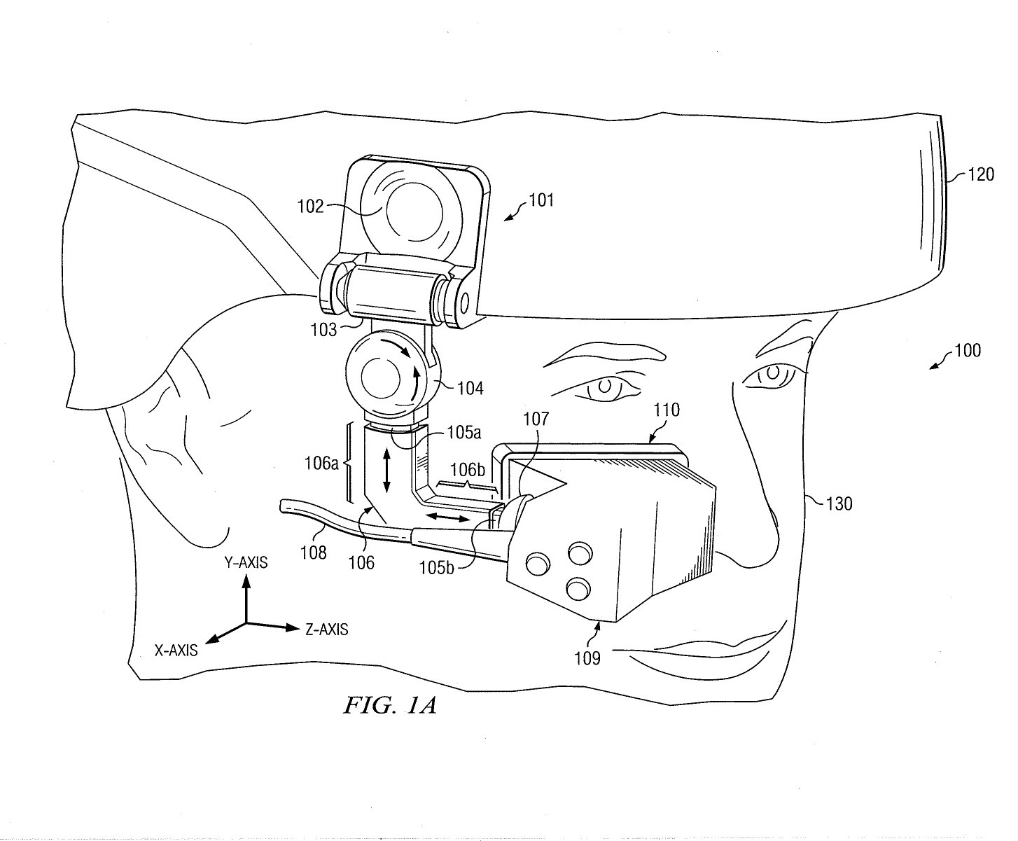

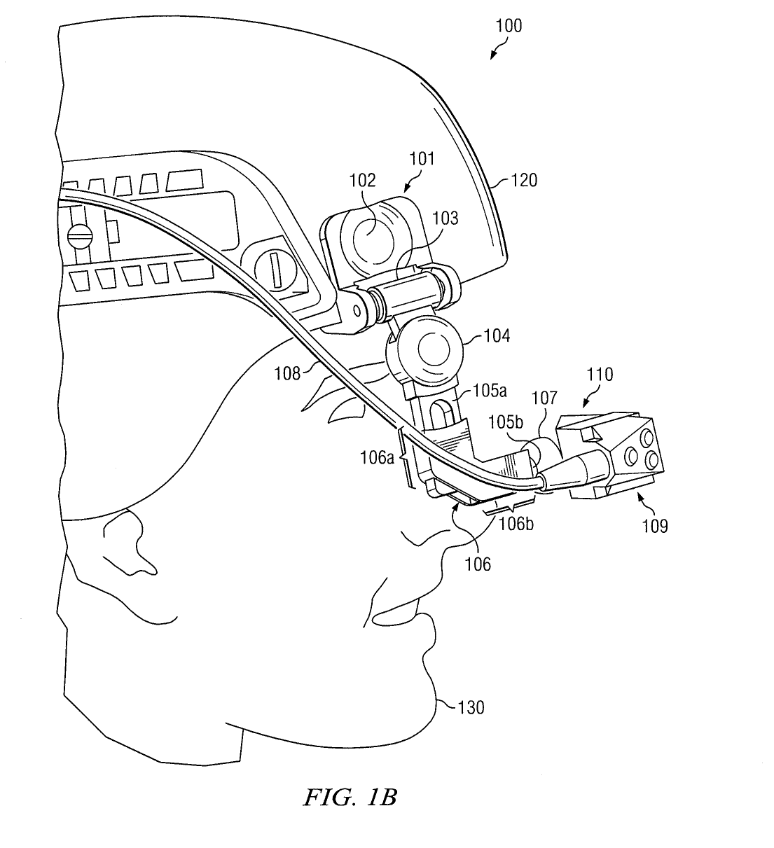

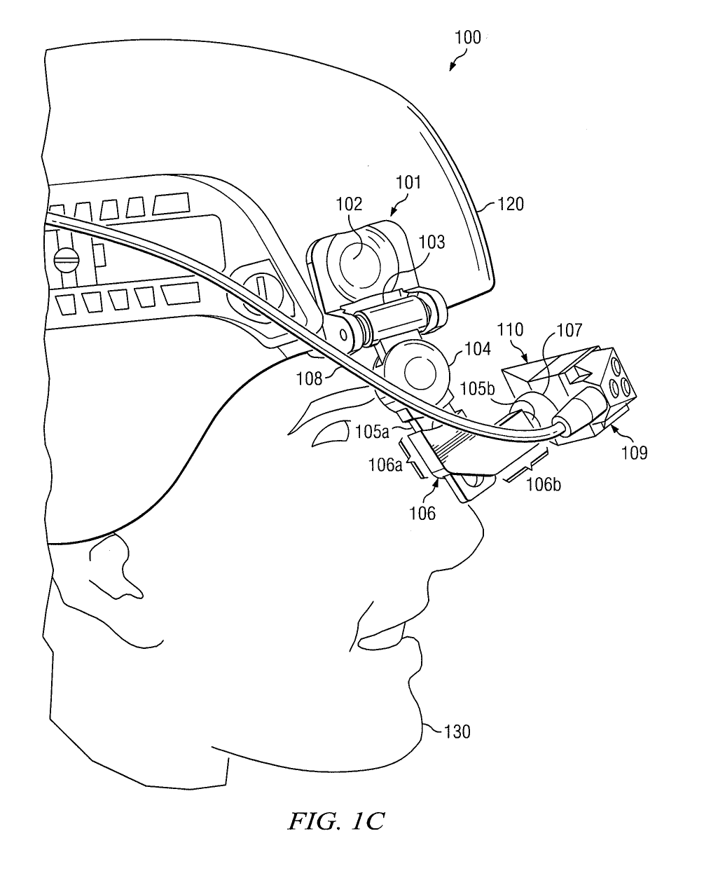

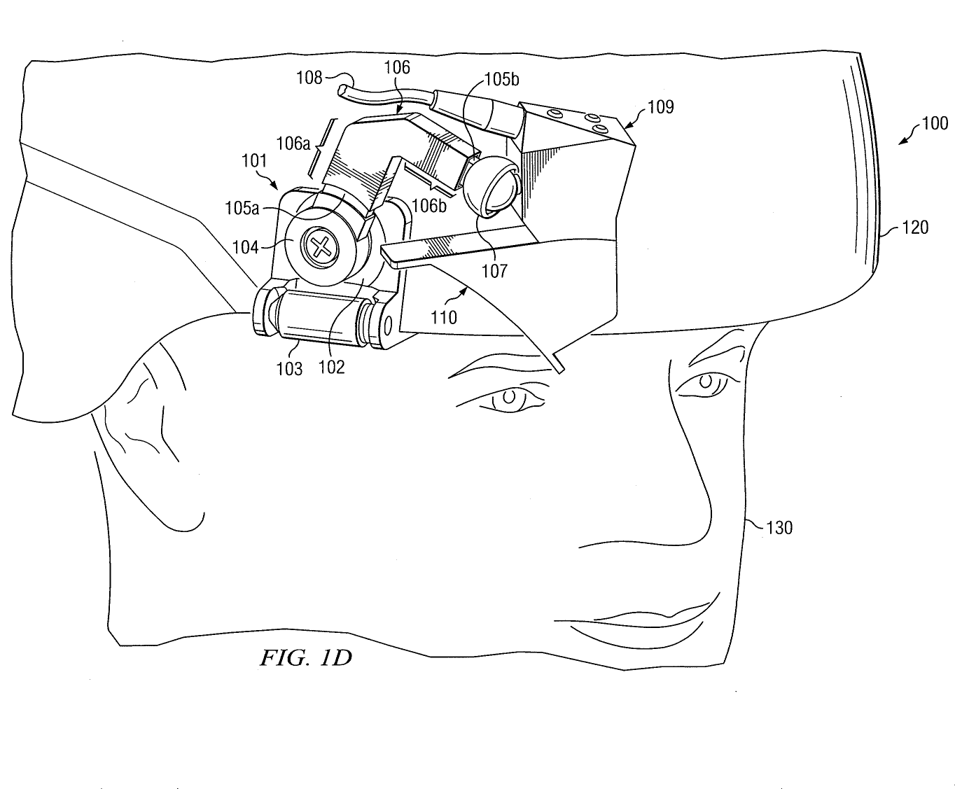

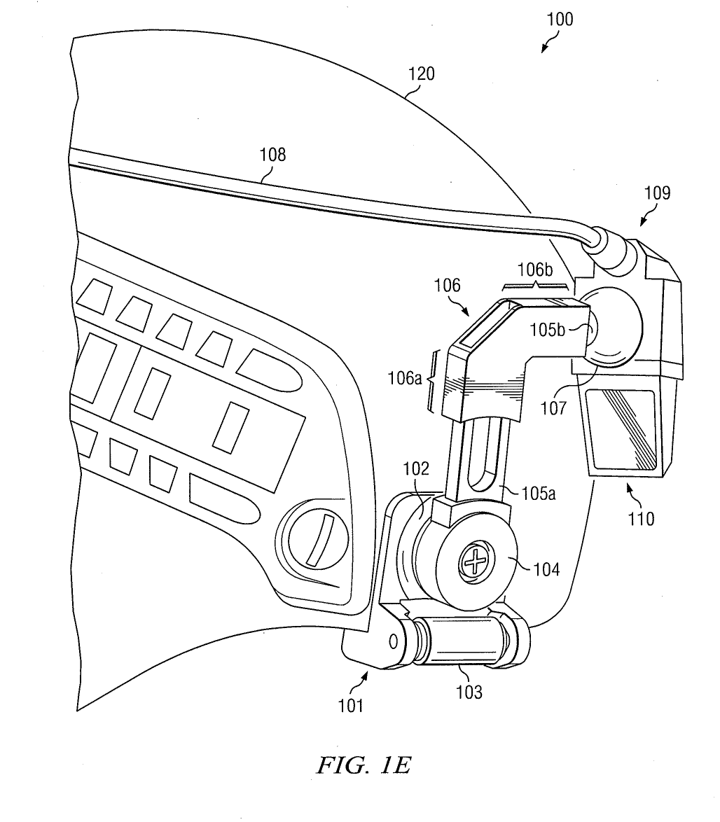

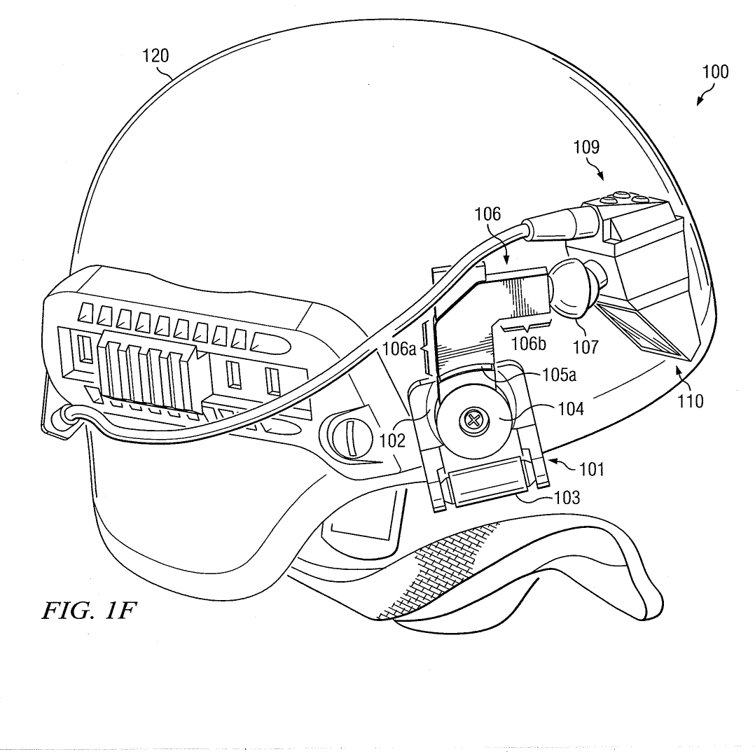

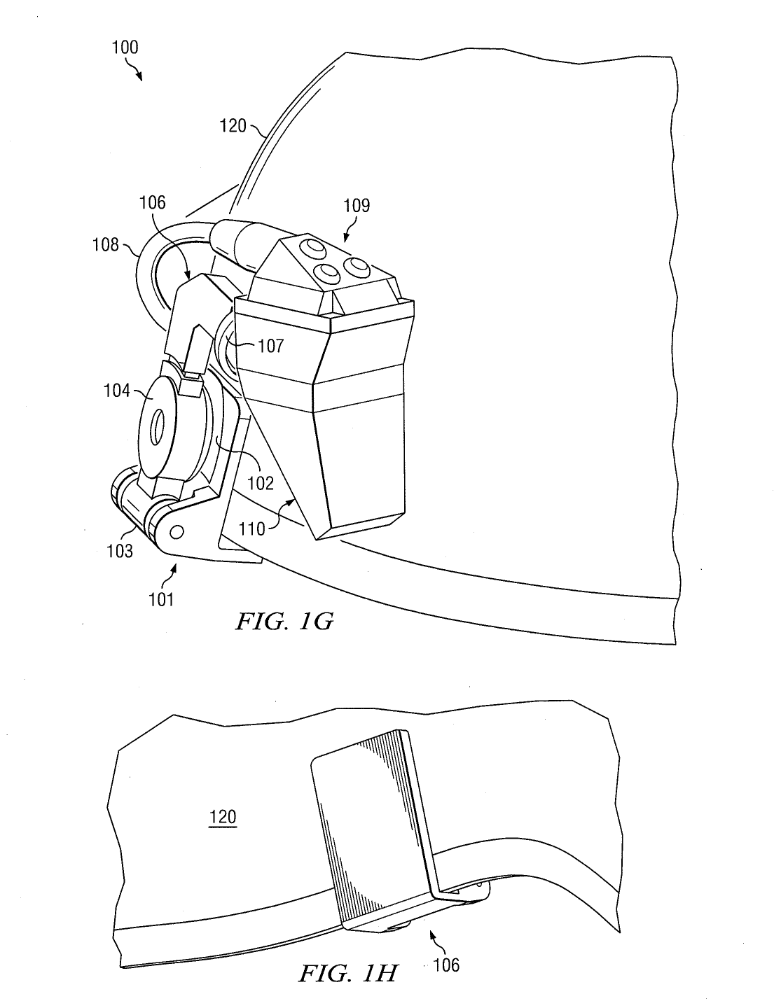

Embodiments of the present disclosure and its advantages are best understood by referring to FIGS. 1A through 4B of the drawings, like numerals being used for like and corresponding parts of the various drawings.

FIGS. 1A through 1H illustrate various views of a display mount 100 configured to removably couple a display unit 110 to a helmet 120 and to adjustably position display unit 110 in front of one eye (monocular) or each eye (binocular) of a user 130. Display mount 100 generally includes a helmet clip 101, a detent 102, a flip-up/flip-down pivot 103, a swivel adjustor 104, one or more slide adjustors 105a and 105b, an arm 106, a ball adjustor 107, a cable receptor 108, and a display interface 109. As explained further below, display mount 100 may enable rapid transitioning of display unit 110 between a viewing position within the field of view of user 130 and a storage position substantially or completely outside the field of view of user 130. In addition, display mount 100 may be used to adjust the viewing position of display unit 110 along at least three different axis. Certain display mounts 100 may mechanically retain a desired viewing position of display unit 110, such that display unit 110 consistently returns to the retained viewing position after repeated transitions between viewing and storage positions. FIGS. 1A through 1C illustrate display mount 100 adjusted according to various viewing positions within the field of view of user 130; and FIGS. 1D through 1H illustrate different views of display mount 100 in storage positions outside the field of view of user 130.

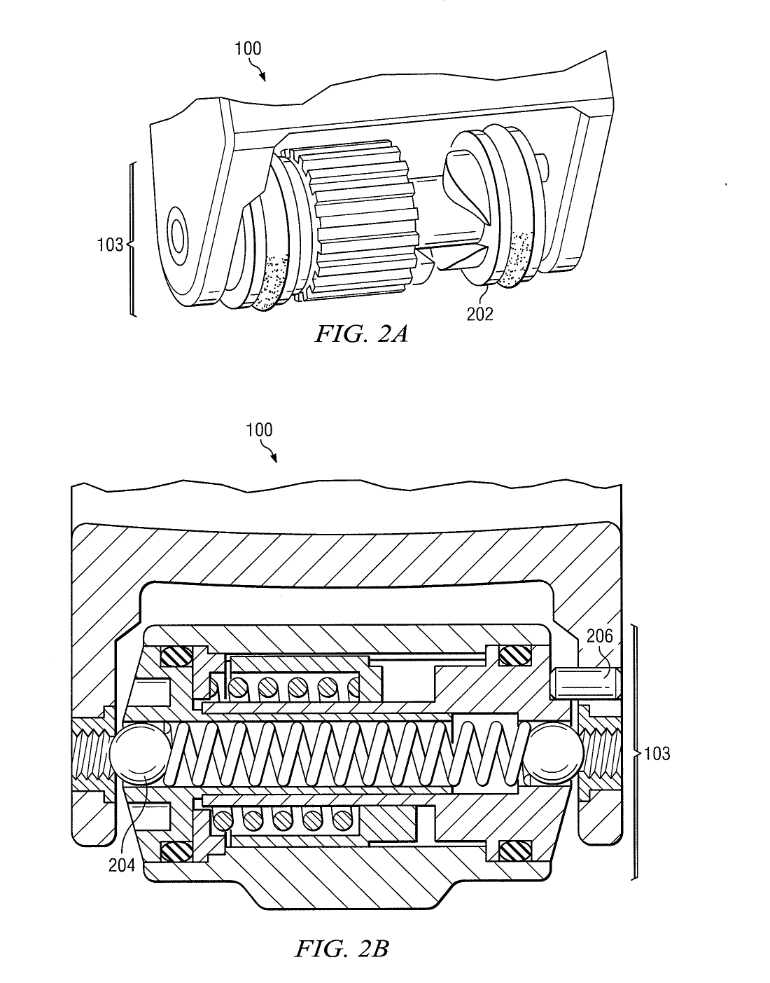

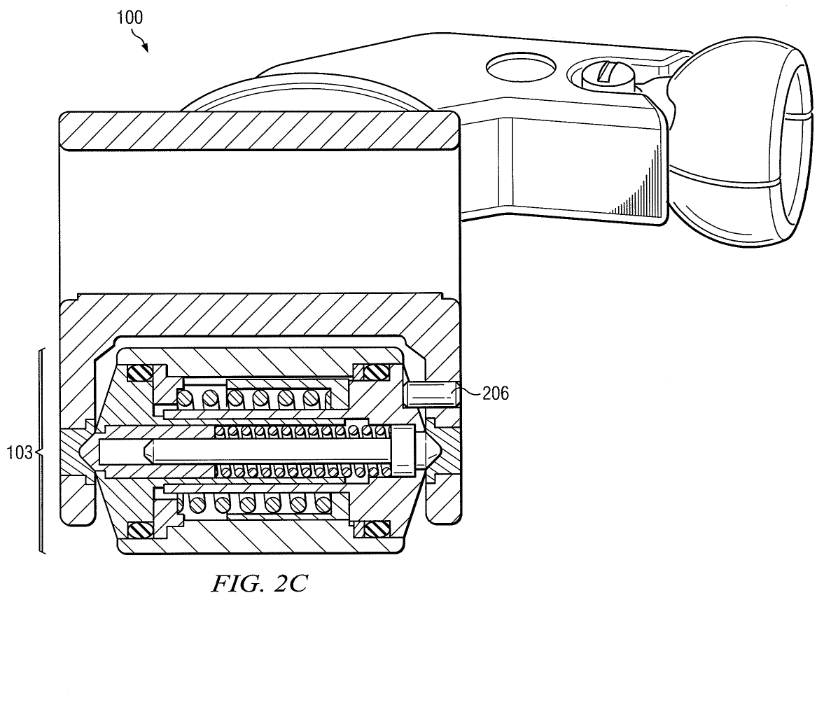

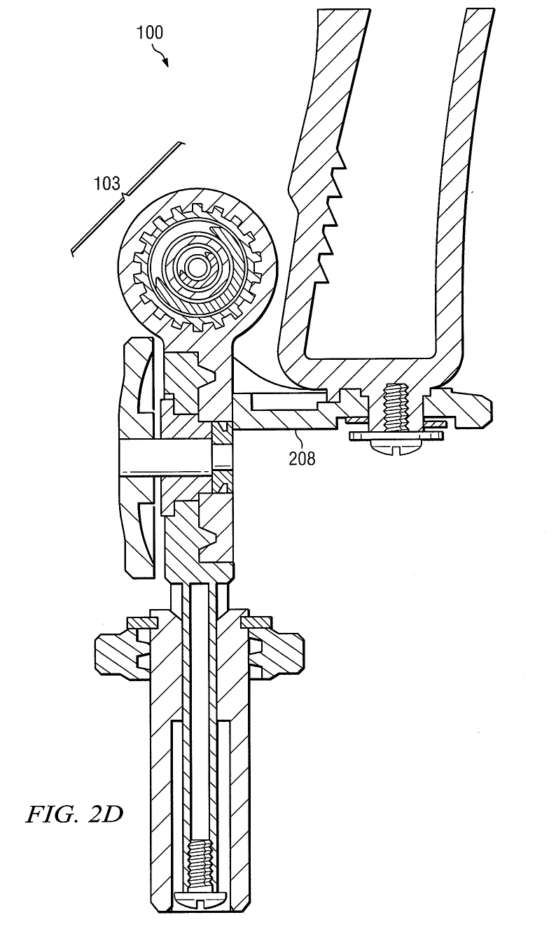

Pivot 103 enables flip-up and flip-down motions that transition display unit 110 between viewing and storage positions. As shown in FIG. 2A, pivot 103 may include a two-position cam arm 202 that facilitates the flip-up/flip-down motions of display mount 100. Cam arm 202 may include multiple spring-loaded, breakaway ball/detent features 204, as shown in FIG. 2B. In certain embodiments, pivot 103 may be mechanically indexed in the flipped-up and flipped-down positions to hold display unit 110 in either the storage position or the viewing position. As shown in the cross-sectional view of FIGS. 2B and 2C, for example, pivot 103 may include a detent 206 that holds pivot 103 in a hands-free storage position completely or substantially outside the field of view of user 130. Display mount 100 may include a cam 208 or other mechanical index to set and hold pivot 103 in the flip-down viewing position. One example of such a cam 208 is shown in the cross-sectional view of FIG. 2D. Pivot 103 may function independently of other adjustors, such that any adjustments made using swivel adjustor 104, slide adjustors 105, and/or ball adjustor 107 may be mechanically retained after repeated flip-up/flip-down motions by pivot 103. In this manner, user 130 can rapidly flip-up display unit 110 out of sight for storing and later rapidly flip-down display unit 110 into the same mechanically retained viewing position as used before.

Various features of display mount 100 may facilitate storing display mount 100 and/or display unit 110 substantially flush against helmet 120 and out of sight of user 130. For example, detent 102 may be shaped to receive swivel adjustor 104 as display mount 100 is flipped upward to a storage position. Providing a storage position for display mount 100 and display unit 110 that is substantially flush against helmet 120 may minimize the risk of snagging during operation. In addition, providing a substantially flush storage position may improve visibility for user 130 by storing display mount 100 and display unit 110 entirely outside the field of view of user 130.

As shown in FIGS. 1A-1C, display mount 100 may be used to adjustably position display unit 110 in front of an eye of the user 130 when display mount 100 is flipped downward to a viewing position. User 130 may articulate swivel adjustor 104, slide adjustors 105, and ball adjustor 107 as desired for a customized view of display unit 110. Swivel adjustor 104, slide adjustors 105, and ball adjustor 107 collectively enable articulation of display unit 110 along an x-axis, a y-axis, and a z-axis, as explained further below. The x-, y-, and z-axis are substantially orthogonal to each other in this example. Although this example includes various adjustment mechanisms with particular adjustment capabilities 104, 105, and 107 any suitable type or number of adjustment mechanisms may be used to adjustably position display unit 110.

Swivel adjustor 104 enables a swivel adjustment of arm 106 along an arc disposed substantially within a plane defined by the y-axis and the z-axis. Swivel adjustor 104 may include one or more friction/locking controls to mechanically retain a desired position for swivel adjustor 104. For example, a thumb lock control or other locking knob may be used.

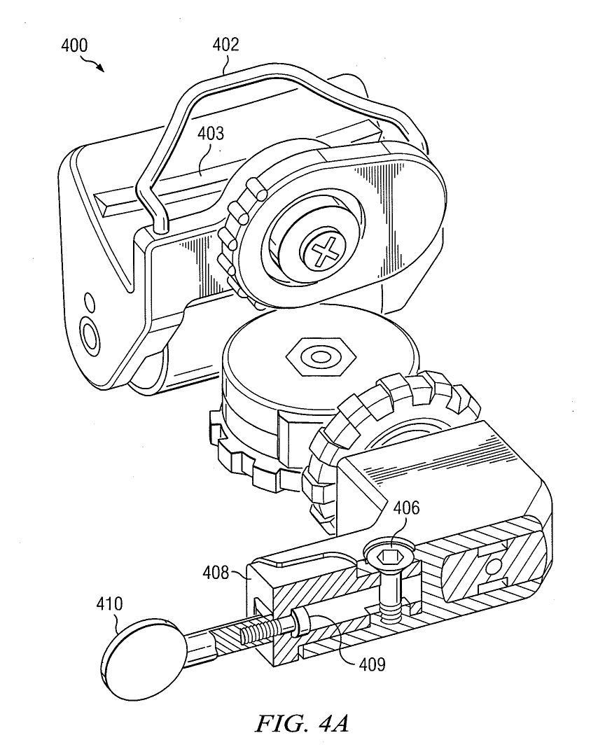

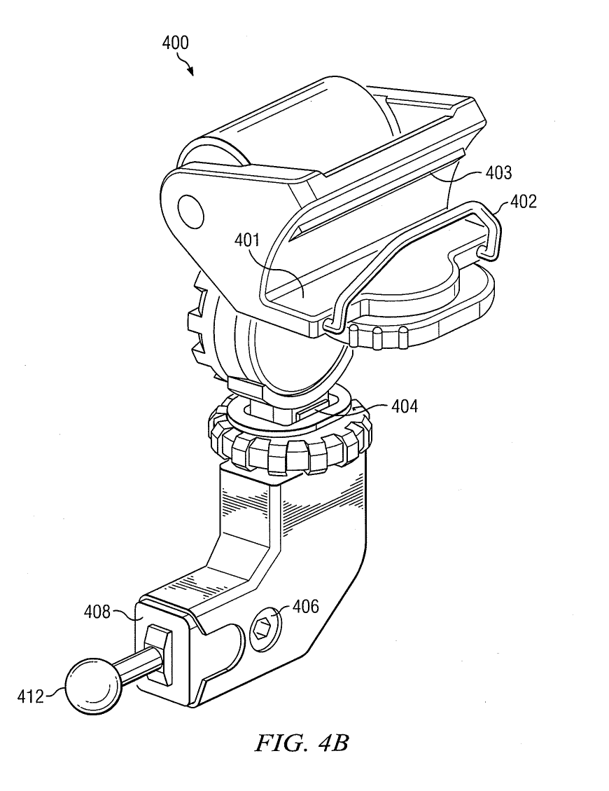

Slide adjustor 105a may enable an adjustment of arm 106 substantially along the y-axis in a direction extending radially outward from the center of swivel adjustor 104. FIG. 1A shows slide adjustor 105a in a collapsed position; and FIGS. 1B and 1C show slide adjustor 105a in extended positions. Slide adjustor 105a may include one or more friction/locking controls to mechanically retain a desired position for slide adjustor 105a. According to one embodiment, a thumb lock control 404 may be used, as shown in FIG. 4A; however, any suitable friction/locking control may be used. In certain embodiments, arm 106 may be revisable at slide adjustor 105a for either left or right eye use.

Slide adjustor 105b may enable adjustment of display interface 109 substantially along the z-axis in a direction extending radially outward from an axis of arm 106. Slide adjustor 105b may include one or more friction/locking controls to mechanically retain a desired position for slide adjustor 105b. For example, a depressible grip 404 may be used, as shown in FIGS. 4A and 4B.

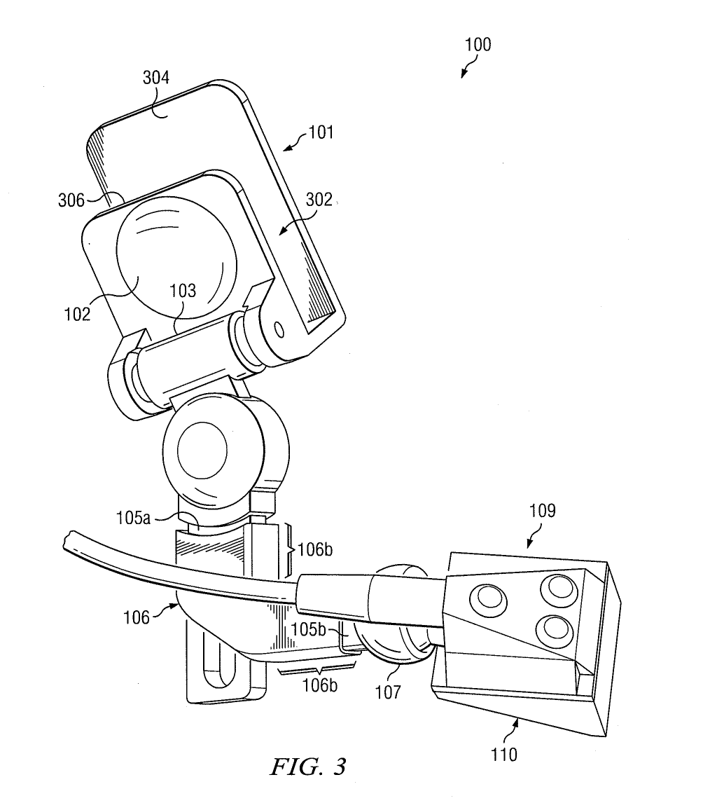

Ball adjuster 107 may enable rotational adjustments substantially along the planes defined by any two of the x-axis, y-axis, and z-axis. Ball adjustor 107 may include one or more friction/locking controls to mechanically retain a desired position for ball adjustor 107. In certain embodiments, ball adjuster 107 may include a ball-cup interface configured to receive a rotatable ball, as shown by way of example in FIGS. 1A-1H, and 3. In alternative embodiments, ball adjuster 107 may include a ball-shaped interface configured to receive a cup, as shown by way of example in FIG. 4B. Certain embodiments may not include ball adjustor 107. For example, FIG. 4A shows one example of a bolt-on interface that, in certain embodiments, may provide a fixed, flat surface to which a display unit 410 may be mounted or otherwise coupled. In certain embodiments, the various friction/locking controls of swivel adjustor 104, slide adjustors 105, and/or ball adjustor 107 may mechanically retain a desired viewing position of display unit 110 even after repeated transitions between viewing and storage positions. In particular embodiments, the various friction/locking controls of swivel adjustor 104, slide adjustors 105, and/or ball adjustor 107 may each function independent of each other and/or independent of pivot 103. The friction/locking controls may prevent movement of display unit 110 as a result of bumping or jarring and may minimize the risk of eye injury to user 130.

In certain embodiments, arm 106 may include integrally formed first and second portions 106a and 106b joined together at approximately a right angle. Arm 106 may be positioned such that a first portion 160a is disposed along an axis substantially parallel to the y-axis and a second portion is disposed along an axis substantially parallel to the z-axis.

Display interface 109 refers to any suitable housing for display unit 110. In certain embodiments, display interface 109 may include a coupler configured to adjustably couple to slide adjustor 105b, arm 106, and/or ball adjustor 107. For example, display interface 109 may include a ball or a cup configured to cooperate with either a cup or a ball, respectively, of ball adjuster 107. FIGS. 1A-1H, 2C-2D, 3, and 4B show different views of various example ball/cup configurations. Display unit 110 refers to any display systems configured to display information to a user. In particular applications, the information displayed by display unit 110 may include maps, thermal imaging data, messages, orders, or other tactical information that may be useful to military, police, firefighters, or other civilian or non-civilian users. In certain embodiments, display interface 109 and display unit 110 may be integrated together as a single unit that may be coupled to display mount 100.

Display mount 100 may be configured to couple to and interface with a variety of different display interfaces 109 and/or display units 110. For example, display mount 100 may be configured to couple to and interface with a variety of different display devices produced by Vuzix, Intevac, Liteye, Rockwell Collins, and/or various other manufacturers. The display devices produced by certain manufactures may include a variety of different interfaces and/or mechanical couplers and interfaces. In certain embodiments, display unit 100 may be provided with a kit of different types of interchangeable mounts or interfaces, as shown by way of example by the differing interfaces of FIGS. 3, 4A, and 4B.

FIG. 3 shows a view of display mount 100 decoupled from helmet 120. As shown in FIG. 3, helmet clip 101 may be configured to receive and grip an edge of helmet 120. In various embodiments, helmet clip 101 may include molded, shaped, or cast parts. In certain embodiments, helmet clip 101 may include a notch 302 defined by two opposing, substantially parallel surfaces 304 and 306. FIG. 1H shows a view of helmet clip 101 gripping an interior of helmet 120. As shown in FIG. 1H, all but the bottom edge of clip 101 of display mount 100 may be transitioned to a position completely above the helmet line, thereby positing display mount 100 and display unit 110 outside the field of view of user 130. Parallel surfaces 304 and 306 may be capable of gripping a variety of helmets 120 having straight edges. In certain embodiments, helmet clip 101 may be interchanged with other clips that facilitate gripping helmets 120 having alternative shapes. One example alternative clip is show in FIGS. 4A and 4B.

FIGS. 4A and 4B show a helmet clip 401 of a display mount 400 according to an alternative embodiment. In the illustrated embodiment, helmet clip 401 includes a shaped wire or “wireform” retainer 402 coupled to a molded piece with an integrally formed, protruding gripper 403. In alternative embodiments, retainer 402 and gripper 403 may be integrally formed from the same material. In operation, gripper 403 and retainer 402 may cooperate together to grip helmets 120 having various shapes including, for example, helmets having curved edges. Certain retainers 402 may includes parts that are molded, shaped, cast and/or otherwise formed of metal, plastic, and/or other suitable material.

Display mount 400 further includes a receiver 408 configured to receive different display coupling devices. As shown in FIG. 4A, for example display unit 410 is coupled to a threaded member 409 inserted into receiver 408. In certain embodiments, display unit 410 may include the optics used for presenting a display to user 130. In alternative embodiments, display unit 410 may provide a flat surface to which such optics may be mounted. FIG. 4B shows a ball and socket mount 412 inserted into receiver 408. Ball and socket mount 412 is similar in structure and function to ball adjustor 107. Ball and socket mount 412 may be used to couple display mount 400 to a variety of alternative display units 110. Thus, receiver 408 may enable the mounting of a variety of different types of display units 410 made by various manufacturers.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims

What is claimed is:

1. A display mount comprising:
a helmet-mountable interface configured to removably couple the display mount to a helmet;
a display interface configured to couple the display mount to a display;
a cam arm configured to transition the display interface along a first arc between viewing and storage positions, the first arc disposed within a plane, the cam arm mechanically indexed in both the viewing and the storage positions such that the cam arm holds the display interface in either the viewing position or the storage position;
a swivel adjustor configured to adjust the display interface along a second arc disposed within a second plane substantially perpendicular to the first plane, the swivel adjustor comprising a locking control for locking a configuration of the swivel adjustor such that the display interface mechanically returns to the locked adjusted position when the display interface transitions from the storage position to the display position, the swivel adjustor adjustments being independent of the cam arm transitions; and
a ball adjustor configured to adjust the display interface along multiple axis, the ball adjustor adjustments being independent of the cam arm transitions and the swivel adjustor adjustments.

2. The display mount of claim 1, wherein the display interface is substantially flush against the helmet when the display interface is in the storage position.

3. A display mount comprising:
a helmet-mountable interface configured to removably couple the display mount to a helmet;
a display interface configured to couple the display mount to a display;
a cam arm configured to position the display interface in a plurality of positions comprising a storage position and a display position; and
an adjustment mechanism configured to adjust, independent of the cam arm, a position of the display interface along an X-axis, a Y-axis and a Z-axis, the X-axis, Y-axis, and Z-axis each being orthogonal to each other, the adjustment mechanism comprising a locking mechanism configured to lock an adjusted position of the display interface such that the display interface mechanically returns to the locked adjusted position when the display interface transitions from the storage position to the display position.

4. The display mount of claim 3, wherein the adjustment mechanism comprises multiple adjustors each configured to adjust, independent of each other, the position of the display interface along at least respective ones of the X-axis, the Y-axis, and the Z-axis.

5. The display mount of claim 3, wherein the adjustment mechanism comprises a slide adjustor configured to adjust the position of the display interface along the Z-axis, the slide adjustor comprising a locking knob for locking a configuration of the slide adjustor.

6. The display mount of claim 3, wherein the adjustment mechanism comprises a slide adjustor configured to adjust the position of the display interface along the Y-axis, the slide adjustor comprising a locking knob for locking a configuration of the slide adjustor.

7. The display mount of claim 3, wherein the adjustment mechanism comprises a swivel adjustor configured to adjust the position of the display interface along a plane comprising the Y-axis and the Z-axis, the swivel adjustor comprising a locking knob for locking a configuration of the swivel adjustor.

8. The display mount of claim 3, wherein the adjustment mechanism comprises a ball adjustor configured to adjust the position of the display interface along at least two of the X-axis, the Y-axis, and the Z-axis.

9. The display mount of claim 3, wherein the helmet-mountable interface comprises a helmet clip comprising an integrated wire retainer.

10. The display mount of claim 3, wherein the storage position of the display interface is substantially flush against the helmet.

11. The display mount of claim 3, wherein the display mount provides a reversible configuration, the reversible configuration comprising a left-eye configuration and a right-eye configuration.

12. The display mount of claim 3, wherein display mount is configured to absorb mechanical shock, such that the locking mechanism of the adjustment mechanism is configured to maintain the adjusted position of the display interface as a result of the mechanical shock.

13. The display mount of claim 3, wherein substantially all of the display mount is above a bottom edge of the helmet when the display mount is in the storage position.

14. The display mount of claim 3, wherein the display interface, the cam arm, and the adjustment mechanism are above a bottom edge of the helmet when the display mount is in the storage position.

15. The display mount of claim 3, further comprising a detent configured to receive at least a portion of the adjustment mechanism when the display mount is in the storage position.

16. The display mount of claim 3, further comprising a receiver configured to couple the display mount to the display interface and to another display interface different from the display interface.

17. The display mount of claim 3, further comprising an integrated wire retainer configured to clip the display mount to a curved surface of the helmet.

18. The display mount of claim 3, wherein the helmet-mountable interface comprises a helmet clip comprising a notch configured to receive a substantially planar surface of the a helmet.

19. A method for adjusting the position of a monocular display, the method comprising:
coupling the monocular display to a helmet using a display mount;
adjusting the position of the monocular display along a first axis using a first adjustor;
locking a configuration of the first adjustor;
adjusting the position of the monocular display along a second axis using a second adjustor different from the first adjustor, the first axis perpendicular to the second axis;
locking a configuration of the second adjustor;
flipping the monocular display to a storage position substantially flush with a surface of the helmet; and
flipping the helmet to a viewing position comprising the locked configuration of the first adjustor and the locked configuration of the second adjustor.

20. The method of claim 19, further comprising:
providing a kit of helmet clips, each helmet clip configured to couple the helmet mount display to a respective one of a plurality of helmet shapes, each helmet shape being different from each other helmet shape; and
providing a kit of display interfaces, each display interface configured to couple a display mount to a respective one of a plurality of displays, each display being of a type different from the type of each other display.
